(19) United States
(12) Patent Application Publication
(10) Pub. No.: US 2016/0290372 A1
(43) Pub. Date: Oct. 6, 2016

(54) FLUID CIRCULATION SYSTEM

(71) Applicant: Deere & Company, Moline, IL (US)

(72) Inventor: Steven R. Fliearman, Coffeyville, KS (US)

(21) Appl. No.: 14/676,058

(22) Filed: Apr. 1, 2015

(51) Int. Cl. F15D 1/00

(52) U.S. Cl. CPC F15D 1/008

(57) ABSTRACT

A fluid circulation system configured to circulate a fluid from a fluid tank to a machine and back to the fluid tank. The fluid circulation system includes a first fluid pumping device having a pump inlet and a pump outlet. The inlet is in communication with the fluid tank. The system also includes a housing for at least partially containing the machine. The housing is in communication with the pump outlet. Additionally, a return conduit is positioned to permit fluid flow from the housing to the fluid tank. The system further includes an air introduction device configured to induce air into the fluid. The fluid circulation system is free of a second fluid pumping device.

### BACKGROUND

The present disclosure relates to a fluid circulation system. In particular, the present disclosure relates to a fluid circulation system for returning fluid without the use of a dedicated pumping device.

### SUMMARY

In one embodiment, the disclosure provides a fluid circulation system configured to circulate a fluid from a fluid tank to a machine and back to the fluid tank. The fluid circulation system includes a first fluid pumping device having a pump inlet and a pump outlet. The inlet is in communication with the fluid tank. The system also includes a housing for at least partially containing the machine. The housing is in communication with the pump outlet. Additionally, a return conduit is positioned to permit fluid flow from the housing to the fluid tank. The system further includes an air introduction device configured to induce air into the fluid. The fluid circulation system is free of a second fluid pumping device.

In another embodiment the disclosure provides a fluid circulation system configured to circulate a fluid from a fluid tank to a machine and back to the fluid tank. The fluid circulation system includes a fluid pumping device having a pump inlet and a pump outlet. The inlet is in communication with the fluid tank. A housing is included for at least partially containing the machine. The housing is in communication with the pump outlet. The system also includes a first conduit configured to permit fluid flow from the pump outlet to the housing. A return conduit is configured to permit fluid flow from the housing to the fluid tank. Also, an air introduction device is positioned at the first conduit. A second conduit is coupled between the air introduction device and an air source.

In another embodiment the disclosure provides a method for circulating fluid from a fluid tank to a machine and back to the fluid tank. The method includes moving the fluid from the fluid tank to a housing at least partially containing the machine and introducing air into the fluid as the fluid moves to the housing. The method also includes separating the air from the fluid as the fluid enters the housing, and thereby increasing an internal pressure within the housing. Also, the method includes lubricating portions of the machine with the fluid within the housing, and expelling the fluid from the housing to the fluid tank with the internal pressure.

Other aspects of the disclosure will become apparent by consideration of the detailed description and accompanying drawings.

### BRIEF DESCRIPTION OF THE DRAWINGS

FIG. 1 is a schematic of a fluid circulation system having an air introduction device.

FIG. 2 is a schematic of another fluid circulation system having the air introduction device of FIG. 1.

FIG. 3 is a schematic of a fluid circulation system having another air introduction device.

FIG. 4 is a schematic of a fluid circulation system having yet another air introduction device.

FIG. 5 is a schematic of a fluid circulation system with a plurality of housings and an air introduction device.

FIG. 6 is a schematic of another fluid circulation system with a plurality of housings and an air introduction device.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways.

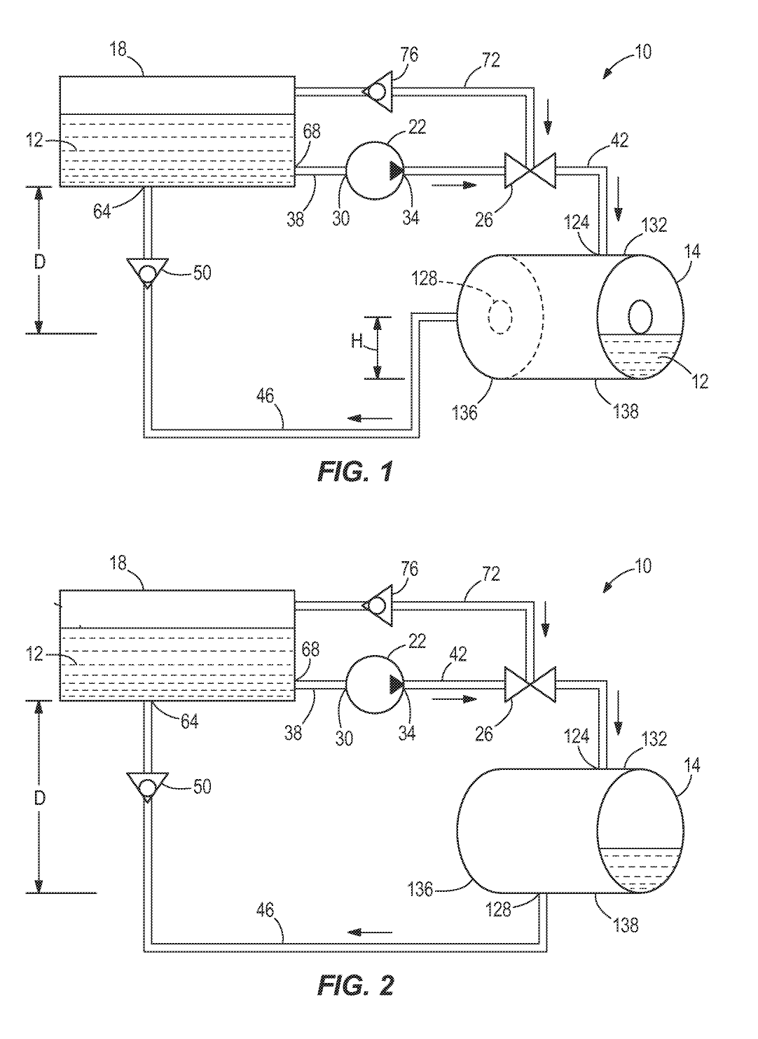

FIGS. 1 and 2 illustrate schematically a fluid circulation system 10 for circulating a fluid 12 (e.g., oil or another lubricating/cooling medium) from a fluid tank 18 to machinery, such as a reciprocating or rotary machine (e.g., a motor or an engine) or other machine requiring lubrication or cooling, which is at least partially enclosed within a housing 14 sealed to contain an internal pressure. The fluid circulation system 10 may include one or more fluid pumping devices 22. As depicted, a fluid pumping device 22 (i.e., a pump) and an air introduction device 26 are positioned between the fluid tank 18 and the housing 14. The pump 22 has a suction side 30 with an inlet and a discharge side 34 with an outlet. An inlet conduit or pipe 38 connects the fluid tank 18 with the suction side 30 of the pump 22. A discharge conduit or pipe 42 extends between the discharge side 34 of the pump 22 and the housing 14. A return conduit or pipe 46 connects the housing 14 with the fluid tank 18 and includes a back flow preventer or check valve 50.

The fluid tank 18 defines a volume partially filled with the fluid 12 and partially filled with air and includes an inlet 64 in communication with the return conduit 46 and an outlet 68 in communication with the inlet conduit 38.

The air introduction device 26, which may be in the form of a Venturi-type injector, is positioned in the discharge conduit 42 and is in communication with the fluid tank 18 via an auxiliary conduit 72 configured with a back flow preventer or check valve 76. The auxiliary conduit 72 couples the air introduction device 26 to air within the fluid tank 18. Alternatively, the conduit 72 can be coupled to an independent source of clean, dry air. In the embodiment of FIGS. 1 and 2, the air introduction device 26, as a conventional Venturi-type injector, includes an inlet, an outlet, and a constriction therebetween with a suction port for connection to the conduit 72.

The housing 14 has an inlet 124 in communication with the discharge conduit 42 and an outlet 128 in communication with the return conduit 46. In the embodiment of FIG. 1, the inlet 124 is generally positioned at or near an upper portion 132 of the housing 14, and the outlet 128 is positioned at a lower portion 136 of the housing 14 at a height H above a housing base 138, the significance of which will be described in greater detail below.

In operation, the pump 22 draws fluid 12 into the first conduit 38 through the outlet 68 of the fluid tank 18. The pump 22 boosts the fluid pressure and directs the fluid 12 to the discharge conduit 42. As the fluid 12 enters the air introduction device inlet, the air introduction device 26 reduces the static pressure of the fluid 12 at the constriction, as is well known. The low pressure fluid 12 induces atmospheric air from the fluid tank 18 (or from another source) into and through the conduit 72, where it is entrained within the passing fluid 12 to form an air-fluid mixture. Within the device 26, the air-fluid mixture recovers a portion of the static pressure lost and flows to the inlet 124 of the housing 14.

As the air-fluid mixture enters the housing 14, the entrained air separates from the fluid and, due to a difference in density, collects within the upper portion 132 of the housing 14 while the fluid 12 lubricates and/or cools the rotating components and collects within the lower portion 136. As additional air enters the housing 14 with the incoming air-fluid mixture, the pressure within the housing 14 builds, which pressurizes the housing volume and, accordingly, the collected fluid 12. Once the internal pressure within the housing 14 reaches a sufficient level, the collected fluid is expelled from the housing 14 through the outlet 128 and into the return conduit 46. Specifically, with the outlet 128 positioned at a height H above the base 138, the fluid 12 collects in the housing 14 until it reaches the height H, at which point, with sufficient applied pressure, it is forced through the outlet 128 against the back pressure within the return conduit 46. In some embodiments, the outlet 128 may be connected to a dip tube within the housing 14 that extends downward from the outlet 128 at a distance less than or equal to the height H. Alternatively, the outlet 128 may be positioned at the base 138 of the housing 14, as illustrated in FIG. 2.

In any configuration, the relationship between 1) the back pressure present in the return conduit 46 (a function generally of the height D of the tank 18 above the outlet 128 and other factors known to those of skill in the art), 2) the height H of the outlet (or opening of a dip tube) with respect to the level of the fluid collected within the lower portion 136, and 3) the pressure developed within the housing 14 generated through the introduction of air will dictate the conditions under which the collected fluid 12 will begin to flow within the return conduit 46 back to the fluid tank 18. As an example, in one embodiment the outlet 128 may be positioned at the base 138 of the housing 14 (see, e.g., FIG. 2), yet fluid 12 will first collect within the lower portion 136 and be driven from the housing 14 only when the pressure developed within the housing 14 by the introduction and collection of air exceeds the back pressure within the return line 46. In some applications the pressure developed within the housing 14 may be greater than 5 psig, and more particularly may be greater than 10 psig, and/or may range from approximately 5 to 15 psig. The air induced through the injector 26 during operation may be less than ten standard cubic feet per hour, and more particularly may range from approximately seven to ten standard cubic feet per hour.

The fluid 12 returned to the fluid tank 18 remains in the fluid tank 18 for recirculation, and a fluid cooler or other fluid conditioning device (not shown) may be utilized within or without the tank 18 to treat the fluid 12.

According to one embodiment, the fluid circulation system 10 includes only one fluid pumping device 22 and the system completes recirculation of the fluid 12 through generation of pressure within the housing 14 as a driving force and without the use of a separate motive device (e.g., a return pump or scavenge pump) within the return conduit 46 or within the housing 14, and additionally without a gravity-based drain. With fewer moving parts required to circulate the fluid, such a system provides for reduced installation and maintenance costs. Additionally, evacuating the fluid from the housing 14, as discussed herein, reduces fluid-related drag losses within the system 10 (i.e., losses due to reciprocating or rotary machinery moving at least partially within a fluid pool). In other embodiments, the fluid circulation system 10 may include a plurality of fluid pumping devices 22.

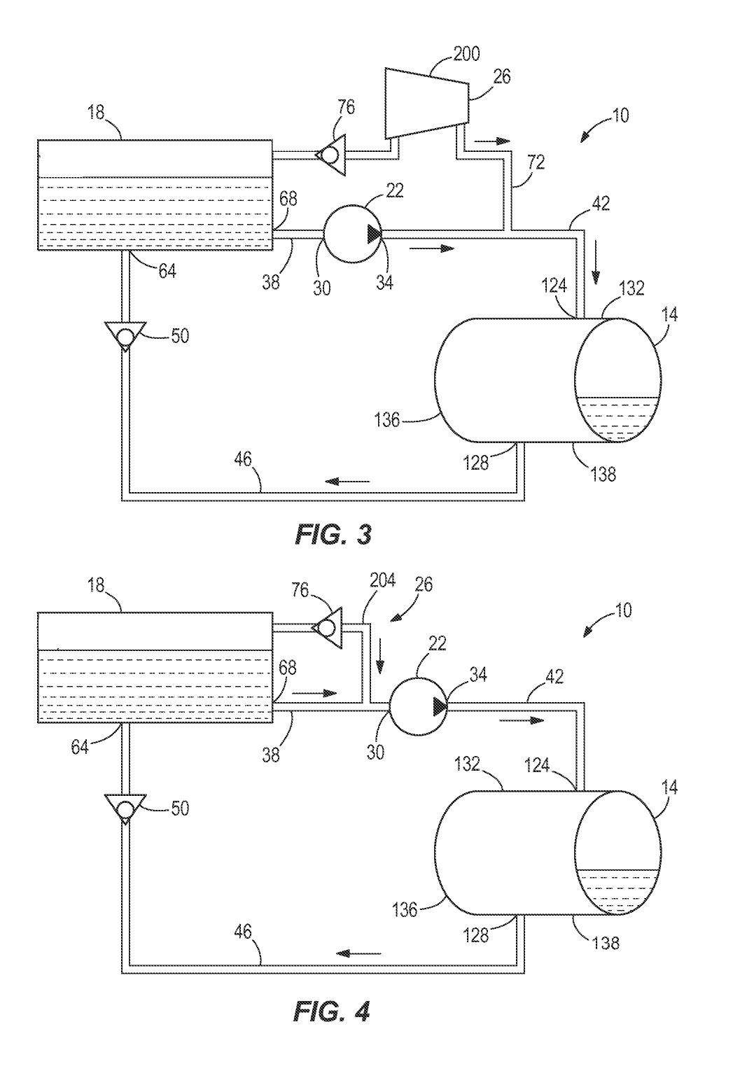

Other air introduction techniques may be employed to introduce air into the fluid stream. Referring to FIG. 3, a compressor 200 in communication with the discharge conduit 42 on the discharge side 34 of the pump 22 serves as an alternative air introduction device. Source air for the compressor 200 can be obtained from the air within the fluid tank 18, as illustrated, or from another source. Compressed air at a pressure higher than the static pressure within the discharge conduit 42 can be introduced or otherwise distributed into the fluid 12 to create the previously described air-fluid mixture.

In other embodiments, air may be introduced to the inlet conduit 38 at the suction side 30 of the pump 22. For example and as illustrated in FIG. 4, a separate conduit 204 may extend from the fluid tank 18 or other source of air to a position near the inlet of the pump 22 at a low enough pressure during operation to induce a flow from the source of air. In some applications, a Venturi-type injector may be positioned on the suction side 30 of the pump 22, depending on the inlet pressure available at the pump and in view of operational pump issues that may arise (e.g., cavitation concerns). A plurality of air introduction devices can therefore be configured to aerate the fluid 12 at the suction side 30 or at the discharge side 34 of the pump 22 to create the air-fluid mixture described above.

Aside from the differences in how air is induced into the fluid 12, however, the systems of FIGS. 3 and 4 operate as described above with respect to FIGS. 1 and 2.

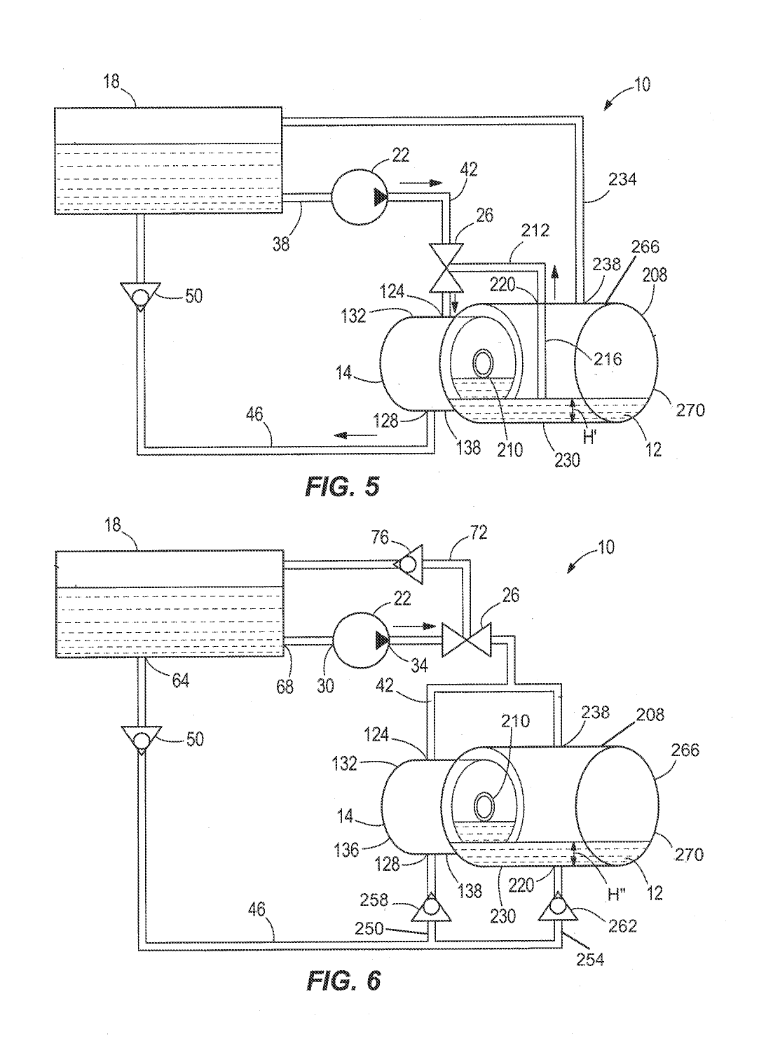

In other embodiments (FIGS. 5 and 6), the reciprocating or rotary machine may output to a gear train or other speed reduction device such that the housing 14 is coupled or connected to a second housing 208. As an example, the second housing 208 could contain a planetary gear arrangement (not shown). Although not illustrated in FIGS. 5 and 6, a drive shaft extends between the housing 14 and the second housing 208 to transmit power between the devices therein. A high pressure seal 210 seals the housing 14 from the second housing 208 and reduces leakage of the fluid 12 from the housing 14 to the second housing 208.

In the embodiment of FIG. 5, the air introduction device 26 positioned in the discharge conduit 42 is in communication with the second housing 208 via an auxiliary conduit 212 that extends into the housing 208 either directly, or via a separately connected dip tube 216 affixed to the outlet 220. The dip tube is positioned a distance (H′) from the base 230 of the housing 208, which corresponds to a maximum level of fluid desired in the housing 208. An additional conduit 234 couples the air within the fluid tank 18 (or to another source of air) to the interior of the second housing 208 through an inlet 238.

During operation of the system of FIG. 5, it is expected that fluid 12 may leak from the higher-pressure housing 14 and collect in the housing 208. The low pressure developed at the constriction of the device 26 induces a portion of the contents (which may include both fluid 12 and air) of the second housing 208 through the conduit 212 or dip tube 216, into the device 26, and into the discharge conduit 42, where it is entrained within the passing fluid 12 to form an air-fluid mixture. Specifically, with the dip tube 216 positioned at the height H′ above the base 230, fluid 12 collects in the second housing 208 until it reaches the height H′, at which point it is effectively scavenged or removed from the second housing 208 via induction and ultimately reintroduced into the circulation system through the air introduction device 26. The volume of fluid/air removed from the housing 208 is replaced by air through conduit 234.

In another embodiment (FIG. 6), the discharge conduit 42 instead splits downstream of the device 26 and enters both housings 14 and 208, with housing 208 now sealed to contain an internal pressure. An outlet conduit 250, 254 from each housing 14, 208 includes a separate back flow preventer or check valve 258, 262, respectively, and connects each respective housing 14, 208 to the return line 46. Also with reference to FIG. 6, the outlet 220 can be positioned at the base 230 of the housing 208, but in other embodiments, the outlet 220 may be positioned between an upper portion 266 and a lower portion 270 at a height above the base 230 (e.g., height H″), similar in configuration to the outlet 128 of the housing 14 illustrated in FIG. 1.

The operation of the system of FIG. 6 is similar to that described above with respect to FIGS. 1 and 2 (in view of the reciprocating or rotary machine and coupled gear train of FIG. 5) except that the air-fluid mixture enters both of the housings 14, 208, where an increase in pressure is developed, as previously described, to expel the fluid 12 from the housings 14, 208 against the back pressure within return conduit 46. The system need not be configured such that the same pressure is developed within each of housings 14, 208.

Various features and advantages of the disclosure are set forth in the following claims.

What is claimed is:

1. A fluid circulation system configured to circulate a fluid from a fluid tank to a machine and back to the fluid tank, the fluid circulation system comprising:
a first fluid pumping device having a pump inlet and a pump outlet, the inlet in communication with the fluid tank;
a housing for at least partially containing the machine, the housing in communication with the pump outlet;
a return conduit positioned to permit fluid flow from the housing to the fluid tank; and
an air introduction device configured to induce air into the fluid, wherein the fluid circulation system is free of a second fluid pumping device.

2. The fluid circulation system of claim 1, wherein the air introduction device is positioned between the pump outlet and the housing.

3. The fluid circulation system of claim 1, wherein the air introduction device is positioned between the fluid tank and the pump inlet.

4. The fluid circulation system of claim 1, wherein the air introduction device is in fluid communication with the fluid tank.

5. The fluid circulation system of claim 1, wherein the air introduction device is a Venturi-type injector.

6. The fluid circulation system of claim 1, wherein the air introduction device includes a compressor.

7. The fluid circulation system of claim 1, further comprising a second housing for at least partially containing a gear train coupled to the machine, an interior of the second housing in communication with the pump outlet.

8. A fluid circulation system configured to circulate a fluid from a fluid tank to a machine and back to the fluid tank, the fluid circulation system comprising:
a fluid pumping device having a pump inlet and a pump outlet, the inlet in communication with the fluid tank;
a housing for at least partially containing the machine, the housing in communication with the pump outlet;
a first conduit configured to permit fluid flow from the pump outlet to the housing;
a return conduit configured to permit fluid flow from the housing to the fluid tank;
an air introduction device positioned at the first conduit; and
a second conduit coupled between the air introduction device and an air source.

9. The fluid circulation system of claim 8, wherein the air introduction device is a Venturi-type injector.

10. The fluid circulation system of claim 9, wherein the Venturi-type injector includes a suction port coupled to the second conduit.

11. The fluid circulation system of claim 8, wherein the air source is compressed air.

12. The fluid circulation system of claim 8, wherein the fluid pumping device is the only pumping device in the fluid circulation system.

13. A method for circulating fluid from a fluid tank to a machine and back to the fluid tank, the method comprising:
moving the fluid from the fluid tank to a housing at least partially containing the machine;
introducing air into the fluid as the fluid moves to the housing;
separating the air from the fluid as the fluid enters the housing, thereby increasing an internal pressure within the housing;
lubricating portions of the machine with the fluid within the housing; and
expelling the fluid from the housing to the fluid tank with the internal pressure.

14. The method of claim 13, wherein introducing the air into the fluid as it moves to the housing means inducing air into the fluid using a Venturi-type injector.

15. The method of claim 13, wherein introducing the air into the fluid as it moves to the housing means introducing compressed air into the fluid.

16. The method of claim 13, wherein moving the fluid from the fluid tank to a housing means moving the fluid with a pump, and wherein introducing the air into the fluid as it moves to the housing means inducing air into the fluid adjacent a suction side of the pump.

17. The method of claim 13, wherein introducing air into the fluid includes inducing a flow of air from the fluid tank.

18. The method of claim 13, wherein expelling the fluid from the housing to the fluid tank with the internal pressure means expelling the fluid from the housing with an internal pressure greater than 5 psig.

19. The method of claim 13, wherein introducing air into the fluid means introducing air into the fluid at a rate of less than 10 standard cubic feet per hour.
